(19) United States
(12) Patent Application Publication
(10) Pub. No.: US 2025/0242320 A1
(43) Pub. Date: Jul. 31, 2025

(54) AGITATOR

(71) Applicant: NIPPON COKE & ENGINEERING CO., LTD., Tokyo (JP)

(72) Inventors: Tsuyoshi FUKAGAWA, Tochigi (JP); Hiroshi TAKAHASHI, Tochigi (JP); Shinya NAGATA, Tochigi (JP); Tsutomu KAMIYAMA, Tochigi (JP); Yosuke NAKANO, Tochigi (JP)

(73) Assignee: NIPPON COKE & ENGINEERING CO., LTD., Tokyo (JP)

(21) Appl. No.: 18/844,665

(22) PCT Filed: Feb. 24, 2023
(86) PCT No.: PCT/JP2023/006689

§ 371 Date: Apr. 9, 2025

(30) Foreign Application Priority Data
Mar. 10, 2022 (JP) 2022-037533

(51) Int. Cl. B01F 35/93; B01F 27/1125; B01F 27/808

(52) U.S. Cl. CPC B01F 35/93; B01F 27/1125; B01F 27/808

(57) ABSTRACT

To provide an agitator that can improve the heat transfer efficiency of a processing object to be stirred in a container, an agitator (1) includes a temperature control member (20) that is provided to the container (10) receiving the processing object and is configured to adjust a temperature of the processing object by circulating a heat medium; and a stirring member (30) that stirs the processing object. The temperature control member (20) includes a heat exchanger (24) that penetrates a side surface (12) of the container (10) and extends into the container (10). The stirring member (30) includes a rotation shaft (31) that extends in a vertical direction and a first stirring blade (32) that is attached to the rotation shaft (31). The first stirring blade (32) consists of a flat plate member extending from the rotation shaft (31) in a horizontal direction.

### TECHNICAL FIELD

The present invention relates to an agitator.

### BACKGROUND ART

Conventionally, there has been known an agitator that can circulate a heat medium through a jacket surrounding a side surface of a container to heat or cool a processing object in the container when the processing object is stirred by stirring blades installed in the container (see, for example, Patent Literatures 1 and 2).

### CITATION LIST

### Patent Literature

Patent Literature 1: JP 2004-148195 A
Patent Literature 2: JP 2019-171310 A

### SUMMARY

### Technical Problem

The conventional agitator includes the jacket formed on the side surface of the container. Accordingly, the size of the container, that is, the area of the side surface of the container defines a contact area between the processing object in the container and the heat medium that circulates through the jacket. Hence, the conventional agitator has a limited heat transfer area of the jacket, and therefore has difficulty in increasing a thermal energy transfer amount (fuel flow amount) per unit time. Further, the conventional agitator has difficulty in scraping the processing object accumulated at the bottom of the container upward, and the processing object hardly comes into contact with the heat medium that circulates through the jacket. Therefore, it is not possible to sufficiently exchange heat. For these reasons, the conventional agitator has difficulty in improving heat transfer efficiency.

The present invention has been made focusing on the above problems, and an object of the present invention is to provide an agitator that can improve the heat transfer efficiency of a processing object to be stirred in a container.

### Solution to Problem

To achieve the above object, an agitator according to the present invention comprises a container that is configured to receive a processing object; a temperature control member that is provided to the container and configured to adjust a temperature of the processing object by circulating a heat medium; and a stirring member that is configured to stir the processing object in the container. The temperature control member includes a heat exchanger that penetrates a side surface of the container and extends into the container. The heat medium flows into the heat exchanger. The stirring member includes a rotation shaft that extends in a vertical direction and is rotatable in the container; and a first stirring blade that is attached to the rotation shaft. The first stirring blade consists of a flat plate member extending from the rotation shaft in a horizontal direction.

### Advantageous Effects

The agitator according to the present invention can improve the heat transfer efficiency of the processing object to be stirred in the container.

### BRIEF DESCRIPTION OF DRAWINGS

FIG. 1 illustrates an explanatory view of a configuration of an agitator according to a first embodiment with a cross-section of main components.

FIG. 2 illustrates a perspective view illustrating the agitator according to the first embodiment.

FIG. 3 illustrates a plan view illustrating the agitator according to the first embodiment.

FIG. 4 illustrates a cross-sectional view illustrating a temperature control member according to the first embodiment.

FIG. 5 illustrates an explanatory view illustrating a motion of a processing object within a container of the agitator according to the first embodiment.

### DESCRIPTION OF EMBODIMENTS

Hereinafter, an agitator according to the present invention will be described based on a first embodiment illustrated in the drawings.

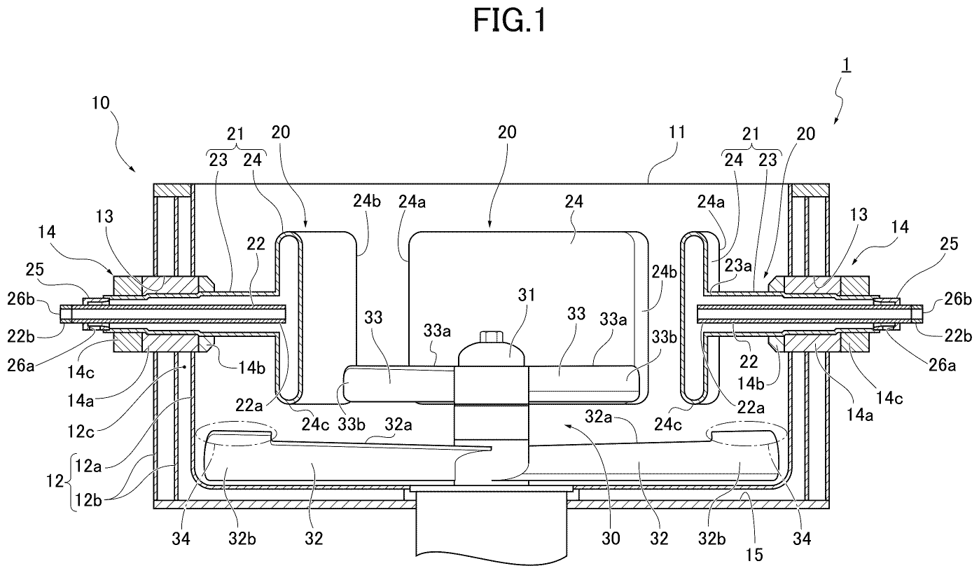

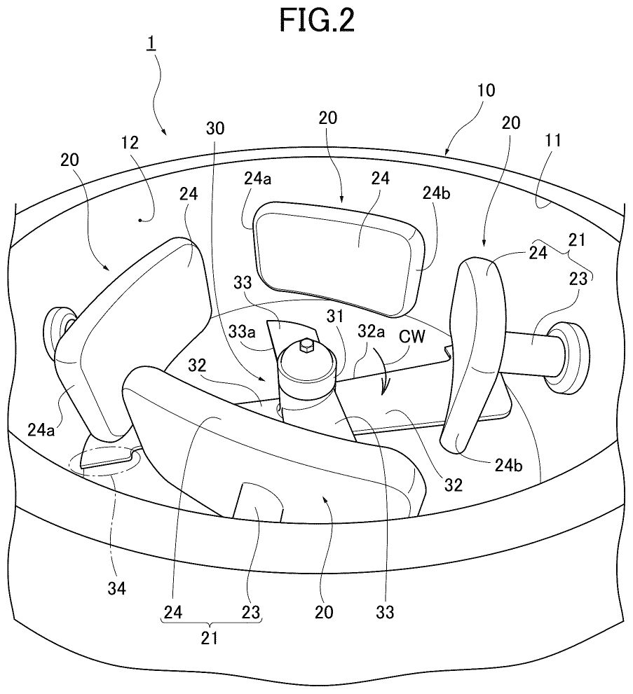

A stirring device or agitator 1 according to the first embodiment is a device that indirectly heats and dries a slurry-like processing object obtained by mixing a solvent such as water or a solvent medium and the processing object while stirring (mixing) the processing object. As illustrated in FIGS. 1 to 3, the agitator 1 includes a container 10, temperature control members 20, and a stirring member 30.

The container 10 is a cylindrical vertical container including an upper portion. The container 10 receives a processing object from an opening 11 of the upper portion. Further, an unillustrated discharge port is formed in a side surface 12 of the container 10. The processing object in the container 10 is discharged from the discharge port to the outside of the container 10. The opening 11 and the discharge port are each openably closed with a lid. Note that the side surface 12 of the container 10 has a double structure to provide the heat insulation property and includes an inner wall 12a, an outer wall 12b, and a space 12c between the inner wall 12a and the outer wall 12b.

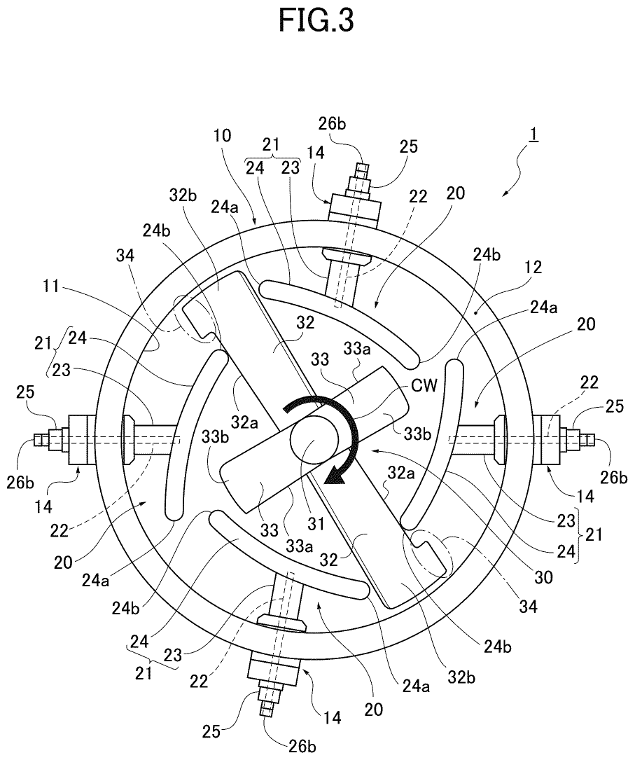

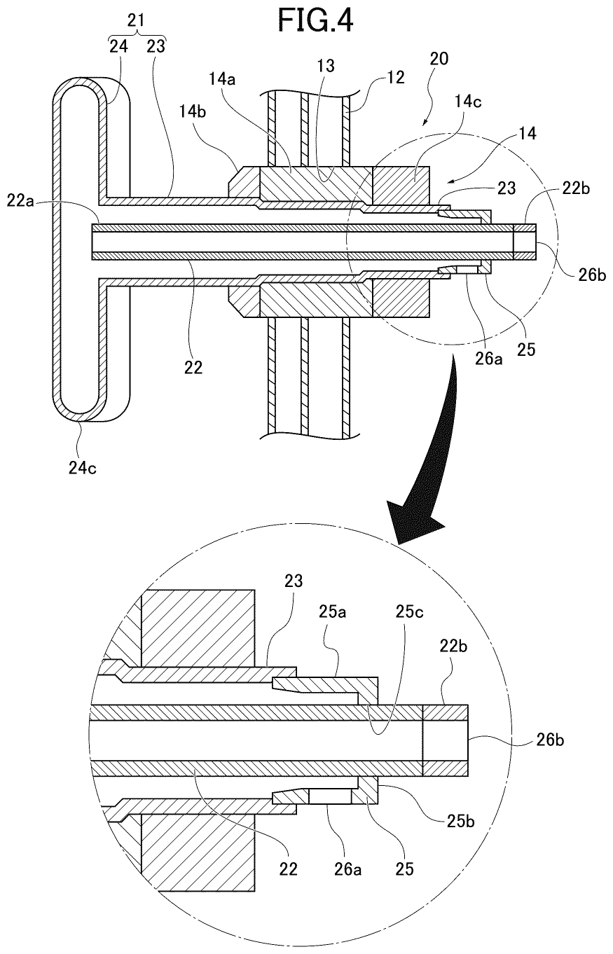

The temperature control members 20 are provided to the side surface 12 of the container 10 and configured to transfer the heat of saturated steam, which is a heat medium, to the processing object in the container 10 and indirectly heat the processing object. The agitator 1 of the first embodiment includes the four (a plurality of) temperature control members 20 in a circumferential direction of the container 10 (see FIG. 3). Further, each of the temperature control members 20 has a double pipe structure in which an inner pipe 22 is disposed inside an outer pipe 21 (see FIG. 4).

The outer pipe 21 is a hollow metal member that penetrates the side surface 12 of the container 10. Note that a material of the outer pipe 21 may be arbitrarily selected as long as the material has high thermal conductivity. The material of the outer pipe 21 is formed of, for example, stainless steel or the like. Further, the side surface 12 includes a through hole 13 which allows the outer pipe 21 to extend through the side surface 12. A tubular support member 14 is provided between the through hole 13 and the outer pipe 21 to support the outer pipe 21. In the embodiment illustrated in FIGS. 1 and 4, the support member 14 are divided into three parts. First, an intermediate member 14a of the support member 14 is attached to the through hole 13. Next, the outer pipe 21 is inserted into the intermediate member 14a attached to the through hole 13. Then, an inner member 14b and an outer member 14c are respectively attached to the intermediate member 14a to support the outer pipe 21.

The outer pipe 21 includes a linear pipe portion 23 that is supported by the support member 14, and a heat exchanger 24 that is formed at a first end 23a of the pipe portion 23 extending into the container 10. In addition, the second end of the pipe portion 23 extending to the outside of the container 10 is open and closed with a cylindrical cap 25. Note that the cap 25 is fixed to the second end of the pipe portion 23 to substantially form the second end of the outer pipe 21 extending to the outside of the container 10. Further, a peripheral surface 25a of the cap 25 includes a first flow port 26a which allows the heat medium to flow therethrough. Furthermore, an end surface 25b of the cap 25 includes a through hole 25c which allows the inner pipe 22 to extend therethrough.

The heat exchanger 24 extends into the container 10. The heat exchanger 24 is formed in a chamber shape into which the heat medium flows. The heat exchanger 24 of the first embodiment has a flat plate shape when the temperature control member 20 is viewed in a direction in which the pipe portion 23 of the outer pipe 21 penetrates the container 10 (the direction in which the temperature control member 20 penetrates the container 10). The heat exchanger 24 forms a rectangular parallelepiped space. Further, in the first embodiment, the pipe portion 23 is coupled to a substantially center part of the heat exchanger 24. Note that the size (volume) of the heat exchanger 24 and the coupling position of the pipe portion 23 are set according to the size of the container 10 and a required thermal energy transfer amount (heat flow rate) per unit time.

The heat exchanger 24 is separated from the side surface 12 of the container 10 by a distance that the pipe portion 23 extends. Accordingly, a gap exists between the heat exchanger 24 and the side surface 12 of the container 10. Further, when the temperature control member 20 is viewed in the vertical direction (in plan view), as illustrated in FIG. 3, the heat exchanger 24 is inclined such that an upstream edge 24a located upstream in a rotation direction CW of a below-described rotation shaft 31 of the stirring member 30 is closer to the side surface 12 of the container 10 than a downstream edge 24b located downstream in the rotation direction CW of the rotation shaft 31. That is, the distance from the side surface 12 of the container 10 to the heat exchanger 24 gradually increases from upstream to downstream in the rotation direction CW of the rotation shaft 31.

Note that “upstream in the rotation direction CW” means an upstream side away from a reference point in a counter-rotation direction to the rotation direction CW. Further, “downstream in the rotation direction CW” means a downstream side away from the reference point in the rotation direction CW.

The inner pipe 22 disposed inside the outer pipe 21 includes open ends. The inner pipe 22 is thinner than the pipe portion 23 and a gap is formed between the inner pipe 22 and the outer pipe 21 to communicate with the first flow port 26a. A first end portion 22a of the inner pipe 22 is opened inside the outer pipe 21, and a second end portion 22b penetrates a through hole 25c formed in the cap 25. Hence, the second end portion 22b of the inner pipe 22 extends out of the outer pipe 21 outside the container 10. Further, the second end of the inner pipe 22 is opened to form a second flow port 26b which allows the heat medium to flow therethrough.

The stirring member 30 is disposed at the bottom of the container 10 and configured to stir the processing object within the container 10. The stirring member 30 includes the rotation shaft 31, a pair of first stirring blades 32 attached to the rotation shaft 31, and a pair of second stirring blades 33 attached to the rotation shaft 31.

The rotation shaft 31 extends in the vertical direction and is rotatably held inside the container 10. The rotation shaft 31 rotates in the clockwise direction (hereinafter referred to as the “rotation direction CW”) when the container 10 is viewed in the vertical direction from above. Further, in the agitator 1 of the first embodiment, the rotation shaft 31 extends through a through hole 16 formed in a bottom surface 15 of the container 10 and penetrates the bottom surface 15 into the container 10. The rotation shaft 31 is supported by a shaft seal (not illustrated) to prevent the processing object from entering the gap between the rotation shaft 31 and the container 10 and prevent foreign matters from entering from the outside. The shaft seal may be, for example, a gas seal. Furthermore, a rotational force of an unillustrated motor (rotary drive source) is appropriately transmitted to the rotation shaft 31.

The pair of first stirring blades 32 comprise or consist of flat plate members respectively extending in opposite directions from the rotation shaft 31 in the horizontal direction. Each of the first stirring blades 32 is inclined such that the downstream side of the first stirring blade 32 located downstream in the rotation direction CW of the rotation shaft 31 is downward. Further, each of the first stirring blades 32 is attached to the rotation shaft 31 at a position lower than a lower end (bottom surface 24c) of the heat exchanger 24. A slight gap is formed between each of the first stirring blades 32 and the bottom surface 15 of the container 10. Furthermore, an extension length of the first stirring blade 32 from the rotation shaft 31 is set such that a distal end 32b of the first stirring blade 32 is positioned below a gap between the container 10 and the heat exchanger 24.

Furthermore, each of the first stirring blades 32 includes an extended portion 34 at the distal end 32b. The extended portion 34 is formed by extending an upper edge 32a of the first stirring blade 32 upward. The distal end 32b of the first stirring blade 32 is positioned below the gap between the container 10 and the heat exchanger 24, and accordingly, the extended portion 34 is positioned under the lower side of the heat exchanger 24 (see FIG. 1).

The pair of second stirring blades 33 comprise or consist of flat plate members respectively extending in opposite directions from the rotation shaft 31 in the horizontal direction. Further, as illustrated in FIG. 3, each of the second stirring blades 33 extends in a direction perpendicular to the first stirring blade 32. Similarly to the first stirring blades 32, each of the second stirring blades 33 is inclined such that the downstream side of the first stirring blade 32 located downstream in the rotation direction CW of the rotation shaft 31 is downward.

Each of the second stirring blades 33 is attached to the rotation shaft 31 at a position higher than the position at which the first stirring blade 32 is attached to the rotation shaft 31 and higher than a lower end (bottom surface 24c) of the heat exchanger 24. That is, each of the second stirring blades 33 is attached to the rotation shaft 31 at a position at which a distal end 33b of the second stirring blade 33 faces the heat exchanger 24. The extension length of the second stirring blade 33 from the rotation shaft 31 is set to be shorter than the extension length of the first stirring blade 32 and to avoid interference with the heat exchanger 24.

Hereinafter, an operation of the agitator 1 of the first embodiment will be described.

To dry the slurry-like processing object by the agitator 1 of the first embodiment, first, a user of the agitator 1 puts a certain amount of the processing object into the container 10 through the opening 11 and closes the opening 11 with an unillustrated lid. The discharge port in the container 10 is closed in advance.

Next, the user drives the unillustrated motor to rotate the rotation shaft 31 of the stirring member 30. Thus, the first stirring blades 32 and the second stirring blades 33 attached to the rotation shaft 31 rotate, and accordingly, the processing object in the container 10 is stirred.

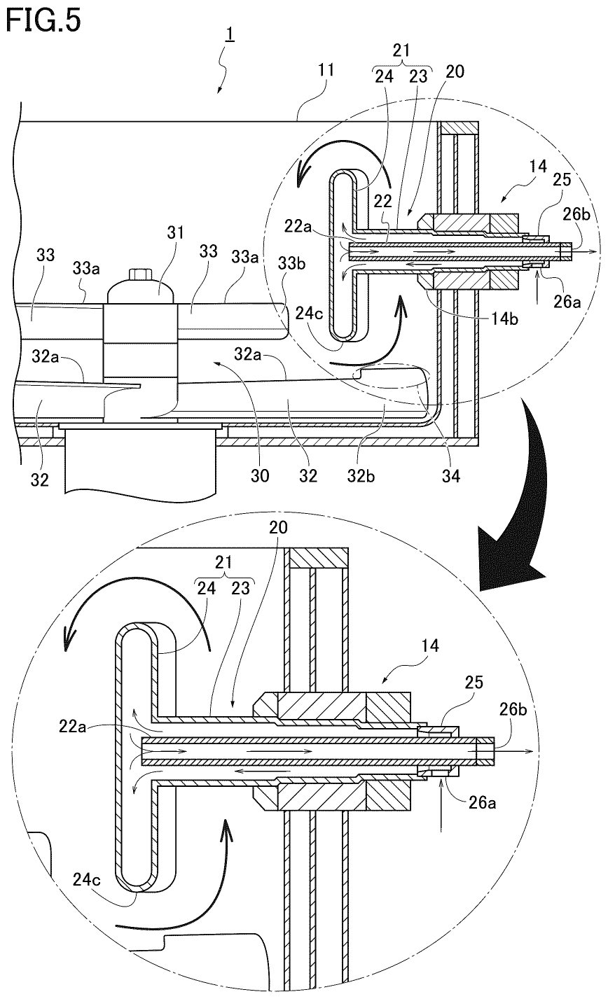

The user rotates the rotation shaft 31 and simultaneously provides the saturated steam, which is the heat medium, into the outer pipe 21 from the first flow port 26a in the outer pipe 21 of the temperature control member 20. As illustrated in FIG. 5, the saturated steam supplied to the outer pipe 21 flows between the outer pipe 21 and the inner pipe 22, flows from the pipe portion 23 into the heat exchanger 24 and is filled in the heat exchanger 24.

On the other hand, the processing object in the container 10 is stirred by the stirring member 30 and thereby moves along the side surface 12 of the container 10. Thus, the processing object comes into contact with the heat exchanger 24, and heat is exchanged between the processing object and the saturated steam (heat medium) in the heat exchanger 24. Hence, the processing object is indirectly heated and dried.

Further, the saturated steam, which is the heat medium, filled in the heat exchanger 24 flows into the inner pipe 22 from the first end portion 22a of the inner pipe 22 opened inside the heat exchanger 24. Then, the heat medium having flown into the inner pipe 22 is discharged from the second flow port 26b in the second end portion 22b of the inner pipe 22 and collected. The saturated steam, which is the heat medium, within the heat exchanger 24 is condensed by being deprived of heat by the processing object and becomes a drain. The heat medium that has become the drain may be discharged to the outside of the heat exchanger 24 through the inner pipe 22 or may be discharged through a discharge hole (not illustrated) formed in the heat exchanger 24.

Furthermore, when the processing object is stirred and indirectly heated for a certain period of time, the user opens the discharge port to take out the processing object in the container 10, and then, the drying processing of the processing object is terminated.

In the agitator 1 of the first embodiment, the temperature control member 20 includes the heat exchanger 24 that penetrates the side surface 12 of the container 10 and extends into the container 10 such that the heat medium flows into the container 10.

Consequently, the agitator 1 of the first embodiment can increase the heat transfer area of the temperature control member 20 and can improve the drying performance of the processing object compared to, for example, a case where a jacket through which the heat medium circulates is formed on the side surface 12 of the container 10. Further, in the agitator 1 of the first embodiment, the heat exchanger 24 extending into the container 10 becomes a baffle, which makes it possible to prevent co-rotation of the processing object and generate a flow in the vertical direction. Thereby, the agitator 1 of the first embodiment can improve the stirring performance of the processing object.

Moreover, in the agitator 1 of the first embodiment, the temperature control member 20 is a separate member from the container 10 and is appropriately provided to the side surface 12 of the container 10. Accordingly, as illustrated in FIG. 3, a plurality of the temperature control members 20 can be provided to the side surface 12 of the container 10. Accordingly, the agitator 1 of the first embodiment can control the heating performance of the processing object by installing the plurality of temperature control members 20 or adjusting the size of the heat exchanger 24.

Further, in the agitator 1 of the first embodiment, the stirring member 30 includes the rotation shaft 31 that extends in the vertical direction and rotates in the container 10, and the first stirring blades 32 that are attached to the rotation shaft 31 and comprise or consist of the flat plate members extending from the rotation shaft 31 in the horizontal direction.

Thus, in the agitator 1 of the first embodiment, the processing object accumulated at the bottom of the container 10 is scraped upward and comes into contact with the heat exchanger 24 extending into the container 10. Consequently, the processing object in the container 10 can exchange heat with the saturated steam having flown into the heat exchanger 24.

As a result, the agitator 1 of the first embodiment can improve the heat transfer efficiency of the processing object stirred in the container 10. With the improved heat transfer efficiency, the agitator 1 can improve the thermal energy transfer amount (heat flow rate) per unit time while using the container with the same capacity as that of the conventional agitator. Accordingly, it is possible to improve drying performance per unit capacity. Consequently, it is possible to minimize the device including the container 10, and it is possible to reduce the cost required when introducing equipment.

Further, in the agitator 1 of the first embodiment, each of the first stirring blades 32 is inclined such that the downstream side of the first stirring blade 32 located downstream in the rotation direction CW of the rotation shaft 31 faces downward. In addition, the distal end 32b of the first stirring blade 32 is provided with the extended portion 34 including the upper edge 32a extending upward. The extended portion 34 is formed at the distal end 32b of the first stirring blade 32, and accordingly, an area of the distal end 32b of the first stirring blade 32 in contact with the processing object becomes larger than that of a vicinity portion of the rotation shaft 31.

The processing object accumulated at the bottom of the container 10 is stirred by the first stirring blades 32 and moves from the center side to the side surface 12 side of the container 10. In contrast, in the agitator 1 of the first embodiment, the extended portion 34 is formed at the distal end 32b of the first stirring blade 32, and the contact area between the first stirring blade 32 and the processing object becomes larger at the distal end 32b.

Consequently, the agitator 1 of the first embodiment can actively scrape upward the processing object which moves from the center side to the side surface 12 side of the container 10 and is accumulated on the side surface 12 side and can efficiently bring the processing object into contact with the heat exchanger 24 extending from the side surface 12. Accordingly, the processing object in the container 10 can sufficiently exchange heat with the saturated steam having flown into the heat exchanger 24. Thus, the agitator 1 of the first embodiment can further improve the heat transfer efficiency of the processing object stirred in the container 10.

Further, in the agitator 1 of the first embodiment, the stirring member 30 includes the second stirring blades 33 each of which comprises or consists of a flat plate member. Here, each of the second stirring blades 33 extends from the rotation shaft 31 in the horizontal direction. Each of the second stirring blades 33 is inclined such that the downstream side of the second stirring blade 33 located downstream in the rotation direction CW of the rotation shaft 31 is downward.

Further, in the first embodiment, the first stirring blades 32 are attached to the rotation shaft 31 at the position lower than the lower end (bottom surface 24c) of the heat exchanger 24, and the extension length from the rotation shaft 31 is set such that the extended portion 34 is positioned under the lower side of the heat exchanger 24. Furthermore, the second stirring blades 33 are attached to the rotation shaft 31 at the position at which the distal end 33b faces the heat exchanger 24. Moreover, the extension length of the second stirring blade 33 from the rotation shaft 31 is set to avoid interference with the heat exchanger 24.

Consequently, the agitator 1 of the first embodiment can stir by the second stirring blades 33 the processing object that has scraped upward by the extended portion 34 and gathered on the center side of the container 10, which improves the stirring efficiency of the processing object. Moreover, in the agitator 1 of the first embodiment, each of the first stirring blades 32 has such a length that the extended portion 34 is positioned under the lower side of the heat exchanger 24, which allows the scraped processing object to enter between the heat exchanger 24 and the side surface 12 of the container 10 as illustrated in FIG. 5. Thereby, it is possible to increase the processing object that comes into contact with the heat exchanger 24, and further improve the overall thermal energy transfer amount (heat flow rate) per unit time in the agitator 1.

Further, in the agitator 1 of the first embodiment, the temperature control member 20 has the double pipe structure that includes the outer pipe 21 and the inner pipe 22 disposed inside the outer pipe 21.

That is, the outer pipe 21 includes the pipe portion 23 that extends through the side surface 12 of the container 10, and the heat exchanger 24 that is formed at the first end 23a of the pipe portion 23 extending into the container 10. The saturated steam (heat medium) flows into the heat exchanger 24. Further, the outer pipe 21 includes the first flow port 26a that is formed at the cap 25 constituting the second end portion of the outer pipe 21 extending to the outside of the container 10. The saturated steam (heat medium) flows through the first flow port 26a.

The inner pipe 22 includes the first end portion 22a that is opened within the outer pipe 21, and the second end portion 22b that extends from the outer pipe 21 outside the container 10. Further, the inner pipe 22 includes the second flow port 26b that is formed at the second end portion 22b extending from the outer pipe 21. The saturated steam (heat medium) flows through the second flow port 26b.

Consequently, the agitator 1 of the first embodiment can increase the circulation efficiency of the saturated steam, which is the heat medium, and improve the thermal energy transfer amount (heat flow rate) per unit time.

Moreover, in the agitator 1 of the first embodiment, the heat exchanger 24 of the temperature control member 20 has the flat plate shape when viewed in the direction that the temperature control member 20 penetrates the container 10. Consequently, the heat exchanger 24 can increase the processing object that comes into contact with the heat exchanger 24 and improve the overall thermal energy transfer amount (heat flow rate) per unit time in the agitator 1.

Further, in the agitator 1 of the first embodiment, the plurality of temperature control members 20 are disposed in the circumferential direction of the container 10. In addition, when the temperature control member 20 is viewed in the vertical direction, the heat exchanger 24 is inclined such that the upstream edge 24a located upstream in the rotation direction CW of the rotation shaft 31 is closer to the side surface 12 of the container 10 than the downstream edge 24b located downstream in the rotation direction CW of the rotation shaft 31.

Accordingly, the processing object to be rotated along the side surface 12 of the container 10 moves while contacting the heat exchanger 24, and thereby is brought closer to the center side of the container 10. That is, the agitator 1 of the first embodiment can move the processing object toward the center of the container 10 while stirring the processing object. Consequently, the agitator 1 of the first embodiment can suppress co-rotation of the processing object and improve the stirring performance. As a result, it is possible to increase the processing object that contacts the heat exchanger 24 and improve the overall thermal energy transfer amount (heat flow rate) per unit time in the agitator 1.

Although the agitator 1 according to the present invention has been described above based on the first embodiment, the specific configuration is not limited to the first embodiment, and design changes, additions, and the like are allowed without departing from the gist of the invention according to the claims.

The first embodiment has been described as the example where the saturated steam is used as the heat medium. However, the heat medium is not limited to the saturated steam, and oil or hot water may be used. Further, the agitator 1 is not limited to a device that indirectly heats and dries the processing object by using a heat medium having a higher temperature than that of the processing object. The agitator 1 may be a device that cools the processing object by using a heat medium having a lower temperature than that of the processing object.

Further, in the first embodiment, the saturated steam that is the heat medium is supplied from the first flow port 26a formed in the outer pipe 21 and flows between the outer pipe 21 and the inner pipe 22 to be filled in the heat exchanger 24. In addition, the heat medium in the heat exchanger 24 is discharged from the second flow port 26b through the inner pipe 22 and is collected. However, the flow direction of the heat medium is not limited thereto. Depending on the type, the temperature, and the like of the heat medium, the heat medium may be supplied from the second flow port 26b formed in the inner pipe 22 and discharged from the first flow port 26a formed in the outer pipe 21 after exchanging heat.

Although the temperature control member 20 has the double pipe structure including the outer pipe 21 and the inner pipe 22 in the agitator 1 of the first embodiment. However, the present invention is not limited thereto. It is only necessary for the temperature control member 20 to allow the heat medium to flow through the heat exchanger 24 extending into the container 10. Hence, for example, the temperature control member 20 may include a first pipe that penetrates the side surface 12 of the container 10 and includes the first flow port 26a, a second pipe that penetrates the side surface of the container 10 and includes the second flow port 26b, and the heat exchanger 24 to which the first and second pipes are coupled. In this case, for example, the heat medium may be supplied from the first flow port 26a formed in the first pipe to fill the heat exchanger 24 and discharged from the second flow port 26b through the second pipe after the heat exchange.

Further, in the agitator 1 of the first embodiment, the heat exchanger 24 is formed in the flat plate shape when viewed in the direction that the temperature control member 20 penetrates the container 10. However, the shape of the heat exchanger 24 is not limited to the shape described in the first embodiment and may be set to any shape based on the overall thermal energy transfer amount (thermal flow rate) per unit time in the agitator 1.

In addition, the example has been described where the four temperature control members 20 are provided in the circumferential direction of the container 10 in the agitator 1 of the first embodiment. However, the number of the temperature control members 20 may be arbitrarily set based on the overall thermal energy transfer amount (thermal flow rate) per unit time in the agitator 1. The plurality of temperature control members 20 do not necessarily need to be provided and a single temperature control member may be provided.

Further, the numbers of the first stirring blades 32 and the second stirring blades 33 are not limited to those described in the first embodiment and may be increased according to the size of the container 10, the type of the processing object, and the like.

Furthermore, the example has been described where the heat medium is the saturated steam in the agitator 1 of the first embodiment. However, oil, hot water, or the like may be used as the heat medium.

Moreover, the example has been described where the rotation shaft 31 of the stirring member 30 penetrates the through hole 16 formed in the bottom surface 15 of the container 10 and extends from the bottom surface 15 into the container 10 in the agitator 1 of the first embodiment. However, the rotation shaft 31 may be supported above the container 10 and inserted into the container 10.

### CROSS-REFERENCE TO RELATED APPLICATION

The present application is based upon and claims the benefit of priority from Japanese Patent Application No. 2022-037533 filed with the Japan Patent Office on Mar. 10, 2022, the entire disclosure of which is incorporated herein by reference.

1. An agitator comprising:
a container that is configured to receive a processing object;
a temperature control member that is provided to the container and configured to adjust a temperature of the processing object by circulating a heat medium; and
a stirring member that is configured to stir the processing object in the container,
wherein the temperature control member comprises a heat exchanger that penetrates a side surface of the container and extends into the container, the heat medium flowing into the heat exchanger, and
wherein the stirring member comprises
a rotation shaft that extends in a vertical direction and is rotatable in the container; and
a first stirring blade that is attached to the rotation shaft and comprises a flat plate member extending from the rotation shaft in a horizontal direction.

2. The agitator according to claim 1,
wherein the first stirring blade is inclined such that a downstream side of the first stirring blade located downstream in a rotation direction of the rotation shaft is downward, and
wherein the first stirring blade comprises a distal end and an extended portion formed at the distal end by extending an upper edge of the distal end upwardly.

3. The agitator according to claim 2, wherein
the stirring member comprises a second stirring blade that is attached to the rotation shaft and extends from the rotation shaft in the horizontal direction,
the second stirring blade comprises a flat plate member inclined such that a downstream side of the second stirring blade located downstream in the rotation direction of the rotation shaft is downward,
the first stirring blade is attached to the rotation shaft at a position lower than a lower end of the heat exchanger and has an extension length from the rotation shaft, the rotation shaft being set such that the extended portion is positioned under the heat exchanger, and
the second stirring blade is attached to the rotation shaft at a position where a distal end of the second stirring blade faces the heat exchanger and has an extension length from the rotation shaft, the extension length being set to avoid interference with the heat exchanger.

4. The agitator according to any one of claims 1 to 3, wherein
the temperature control member has a double pipe structure that comprises an outer pipe and an inner pipe inside an outer pipe,
the outer pipe comprises
a first end portion that penetrates the side surface of the container and extends into the container, the heat exchanger being provided at the first end portion; and
a second end portion that extends to an outside of the container and comprises a first flow port through which the heat medium flows; and
the inner pipe comprises
a first end portion that is opened inside the outer pipe; and
a second end portion that extends out of the outer pipe outside the container and comprises a second flow port through which the heat medium flows.

5. The agitator according to any one of claims 1 to 4, wherein
the heat exchanger has a flat plate shape when viewed in a direction in which the temperature control member penetrates the container.

6. The agitator according to claim 5, wherein
a plurality of temperature control members is disposed in a circumferential direction of the container, and
the heat exchanger comprises an upstream edge located upstream in a rotation direction of the rotation shaft and a downstream edge located downstream in a rotation direction of the rotation shaft, the heat exchanger is configured to incline such that the upstream edge is closer to the side surface of the container than the downstream edge when the heat exchanger is viewed in the vertical direction.
